(19) United States
(12) Patent Application Publication
(10) Pub. No.: US 2022/0198333 A1
(43) Pub. Date: Jun. 23, 2022

(54) RECIPE OPTIMIZATION THROUGH MACHINE LEARNING

(71) Applicant: Applied Materials, Inc., Santa Clara, CA (US)

(72) Inventors: Robert Charles Pack, Morgan Hill, CA (US); Regina Germanie Freed, Los Altos, CA (US); Madhur Singh Sachan, Belmont, CA (US); Tzu-Shun Yang, Milpitas, CA (US)

(21) Appl. No.: 17/545,781

(22) Filed: Dec. 8, 2021

Related U.S. Application Data
(60) Provisional application No. 63/127,939, filed on Dec. 18, 2020.

(51) Int. Cl. G06N 20/00; G06K 9/62

(52) U.S. Cl. CPC G06N 20/00; G06K 9/6262; G06K 9/6256

(57) ABSTRACT

A method includes training a machine learning model with data input including one or more sets of historical recipe parameters associated with producing one or more substrates with substrate processing equipment and target data including historical performance data of the one or more substrates to generate a trained machine learning model. The method further includes identifying one or more sets of additional recipe parameters associated with a level of uncertainty of the trained machine learning model. The method further includes further training the machine learning model with additional data input including the one or more sets of additional recipe parameters and additional target data including additional performance data of one or more additional substrates produced based on the one or more sets of additional recipe parameters to update the trained machine learning model.

### RELATED APPLICATION

This application claims the benefit of U.S. Provisional Patent Application No. 63/127,939, filed on Dec. 18, 2020, the entire content of which is incorporated by reference herein.

### TECHNICAL FIELD

The present disclosure relates to recipe optimization, and, more particularly, recipe optimization through machine learning.

### BACKGROUND

Manufacturing systems produce products based on manufacturing parameters. For example, substrate processing systems produce substrates based on the many parameters of process recipes. Products have performance data based on what parameters were used during production.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method includes training a machine learning model with data input including one or more sets of historical recipe parameters associated with producing one or more substrates with substrate processing equipment and target data including historical performance data of the one or more substrates to generate a trained machine learning model. The method further includes identifying one or more sets of additional recipe parameters associated with a level of uncertainty of the trained machine learning model. The method further includes further training the machine learning model with additional data input including the one or more sets of additional recipe parameters and additional target data including additional performance data of one or more additional substrates produced based on the one or more sets of additional recipe parameters to update the trained machine learning model.

In another aspect of the disclosure, a method includes identifying target performance data of a substrate to be produced by substrate processing equipment. The method further includes providing the target performance data to a trained machine learning model that uses one or more of Gaussian Process Regression (GPR), Bayesian linear regression, Probabilistic Learning, Bayesian Neural Networks, or Neural Network Gaussian Processes. The method further includes obtaining, from the trained machine learning model, predictive data indicative of predictive recipe parameters to be used by the substrate processing equipment to produce one or more substrates having the target performance data.

In another aspect of the disclosure, a system includes a memory and a processing device coupled to the memory. The processing device is to train a machine learning model with data input including one or more sets of historical recipe parameters associated with producing one or more substrates with substrate processing equipment and target data including historical performance data of the one or more substrates to generate a trained machine learning model. The processing device is further to identify one or more sets of additional recipe parameters associated with a level of uncertainty of the trained machine learning model. The processing device is to further train the machine learning model with additional data input including the one or more sets of additional recipes parameters and additional target data including additional performance data of one or more additional substrates produced based on the one or more sets of additional recipe parameters to update the trained machine learning model.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain embodiments.

FIG. 2 illustrates a data set generator to create data sets for a machine learning model, according to certain embodiments.

FIG. 3 is a block diagram illustrating determining predictive data, according to certain embodiments.

FIG. 4A illustrates performance data and uncertainty data used in recipe optimization, according to certain embodiments.

FIGS. 4B-F illustrate plots associated with recipe optimization, according to certain embodiments.

FIGS. 5A-C are flow diagrams of methods associated with recipe optimization, according to certain embodiments.

FIG. 6 is a block diagram illustrating a computer system, according to certain embodiments.

### DETAILED DESCRIPTION

Described herein are technologies directed to recipe optimization through machine learning. Manufacturing systems, such as substrate processing systems, produce products by performing processes that include parameters. Multiple processes (e.g., multi-operation process recipes for nanoscale pattern definition processes) are performed by substrate processing equipment to produce substrates. Processes may include etching, heating, cooling, transporting, depositing layers, implanting ions, etc. Each of the processes have corresponding parameters, such as one or more continuous or categorical settings such as temperature, pressure, power, flow, chemistry, speed, timing, etc. Creation of process recipes for substrate production (e.g., nanoscale pattern definition processes) can be very complex. Attempting to optimize a recipe typically conventionally uses many iterations. An incorrect or sub-optimal parameter in one or more of the processes of a recipe can cause product defects, lower yield, increased energy consumption, etc. Lengthy iterations of updating parameters may impact time-to-market.

Conventional creation of a recipe is a manual process, time consuming, iterative, and costly. Many experiments are typically run and models are created to attempt to model and understanding how and why processes achieve an end goal. Modeling of substrate production uses metrology data gathered after producing substrates (e.g., experiments) using different values of parameters. Experiments may be performed by producing substrates based on a first iteration of a recipe that has parameters, adjusting the parameters in the recipe, producing additional substrates based on the second iteration of the recipe that has the adjusted parameters, and continuing (e.g., hundreds of experiments over the course of a year). Conventional modeling approaches of substrate production may use a number of experiments that may be as many as five or more times the total number of parameters in a recipe. As numbers of processes and number of parameters per process grow, it is typically not possible to perform this number of experiments. Even if it is possible to perform this high number of experiments, advanced statistical modeling methods to converge on a recipe are complex to interpret using methods that are not commonly known by process engineers and that lack a systematic and principled convergence methodology. Further, conventionally the number of experiments do not cover the parameter space uniformly and do not capture the diversity of the data (e.g., parameters) and responses (e.g., metrology data) further complicating analysis. Lacking the ability to model over large multivariate space, one or two factor design of experiments (DOE) are conventionally used to understand the sensitivity relationships among parameters, but it is often a practical impossibility to cover the entire parameter space or capture interactions. Confidence limits of traditional non-probabilistic statistical learning regression models, particularly for small or non-uniformly distributed data sets, are often inaccurate and misinterpreted. Further, the diverse information to be used are conventionally not in an optimal form which further exacerbates this complex problem and does not allow data-driven learning across a range of different recipe DOEs.

To determine the optimal parameters and performance, experimental methods are used. Convergence to an optimal set of parameters via experimental methods is increasingly difficult and complex, particularly for multi-operation process recipes with many parameters. A unique embodiment of machine learning can be used to achieve optimal results more quickly and systematically. Data may be gathered and compiled into a form for machine learning. The machine learning models as described herein may be used to optimize recipe parameters in an efficient timely manner.

The devices, systems, and methods disclosed herein provide recipe optimization through machine learning (e.g., in a systematic principled manner). A processing device receives DOE and/or historical parameters (e.g., one or more sets of historical recipe parameters, one or more historical recipes that include historical parameters) associated with producing at least one substrate with substrate processing equipment. The parameters (e.g., historical recipe parameters) correspond to process operations (e.g., all of the process operations) of a recipe. In some embodiments, the parameters further include parameters or categories of processes of prior operations the substrate has undergone. There may be a large number of parameters particularly for multiple process operation recipes. For example, processes can include one or more of deposition, etching, ion implantation, heating, cooling, transporting a substrate, purging airspace around the substrate, etc. The parameters of the process of transporting the substrate can include speed of transportation, timing of transportation, the ports used, etc. The parameters of the process of heating the substrate can include the temperature of zones, the rate of change of temperature, power, etc. The parameters of the process of etching the substrate can include the materials and/or gases provided to the processing chamber, the flow rate of the gases, temperature, pressure, etc. The parameters of the process of purging of the airspace around the substrate can include flowrate, type of purge gas, temperature, gas, etc. The parameters of the process of cooling of the substrate can include temperature, pressure, flow, rate of cooling, etc.

The machine learning system or processing device further receives historical performance data of the substrate produced via the substrate processing equipment based on the a DOE and/or sets of historical recipe parameters. The historical performance data (associated performance data) can include one or more different types of data, including one or more of ellipsometry thin film thickness, complex refractive index measurements, electrical probe resistivity measurements, SEM or TEM images, metrology derived from SEM or TEM images, functionality measurements, optical emission spectroscopy, etc. The historical performance data can be provided via metrology equipment (e.g., imaging equipment, spectroscopy equipment, ellipsometry equipment, scanning equipment, etc.).

The machine learning system or processing device further trains a machine learning model using data input including the historical parameters and target output including the historical performance data to generate a trained machine learning model.

The processing device determines whether uncertainty (e.g., uncertainty of parameters, uncertainty of inferred response) of the trained machine learning model at any point meets a threshold uncertainty. The trained machine learning model generates multi-variable functions which fit data points, where each data point corresponds to DOE or historical parameters and corresponding performance data of a single substrate. In the gaps between DOE data points where the model is trained, there are peaks of uncertainty which may be derived from an acquisition-type function. Each region that includes uncertainty peaks corresponds to where augmenting the DOE with additional design points improves the model accuracy. Responsive to an uncertainty peak or the uncertainty not meeting a threshold uncertainty (e.g., not being below a threshold uncertainty within a parameter space of interest), the processing device identifies additional recipe parameters associated with the uncertainty peak of the trained machine learning model. The processing device then causes additional substrates to be produced by the substrate processing equipment based on the additional parameters and receives additional performance data (e.g., metrology data) of the additional substrates produced based on the additional parameters. This provides the basis for efficient and optimal adaptive design augmentation process convergence.

The processing device further trains the previously trained machine learning model using the additional parameters and additional performance data to update the trained machined learning model. The further training improves the prediction capability and uncertainty of the model at the specific parameter values and elsewhere as well. The processing device then determines whether the uncertainty (e.g., acquisition or uncertainty function) of the updated trained machine learning model meets criteria (e.g., threshold uncertainty). The criteria may be over the full range of the parameter space or specific to a parameter subspace. Responsive to the uncertainty of the updated trained machine learning model not meeting the criteria (e.g., threshold uncertainty), the operations repeat until the criteria is met. Responsive to meeting the criteria (e.g., threshold uncertainty), the trained machine learning model can then be used.

To use the trained machine learning model, a processing device (e.g., machine learning processing device) receives a recipe to produce a substrate and identifies, based on the recipe, target performance data (e.g., target critical dimensions (CDs), target flatness, target thicknesses of layers, target properties, etc.) of the substrate. The processing device provides the target performance data (e.g., as output) to a trained machine learning model and obtains, from the trained machine learning model, predictive parameters (e.g., one or more inputs indicative of predictive parameters). The processing device optimizes the recipe based on the predictive parameters (e.g., updates parameters of one or more processes of the recipe based on the predictive parameters) and causes the substrate processing equipment to produce substrates based on the recipe that has been optimized.

Aspects of the present disclosure result in technological advantages. The present disclosure provides for less processing of substrates (e.g., less experiments) and metrology performed to optimize a recipe compared to conventional solutions. This saves time, material, wear-and-tear of substrate processing equipment, number of iterations, and cost. Optimal process convergence of the present disclosure is faster than conventional systems and the process may be available for production more quickly than in conventional systems. The present disclosure provides a degree of automated recipe optimization compared to the conventional solutions that are a manual process of highly skilled process engineers. The present disclosure covers a large number of parameters spanning many processes compared to conventional solutions that practically-speaking cover a subset of the parameters over an abbreviated parameter space. The present disclosure determines uncertainty as a function over parameters of the modeling and systematically and efficiently reduces the local and global uncertainty distribution compared to conventional solutions that lack this concept entirely. The present disclosure provides information in an optimal form to allow data-driven learning across a range of different parameters which is not provided by conventional solutions.

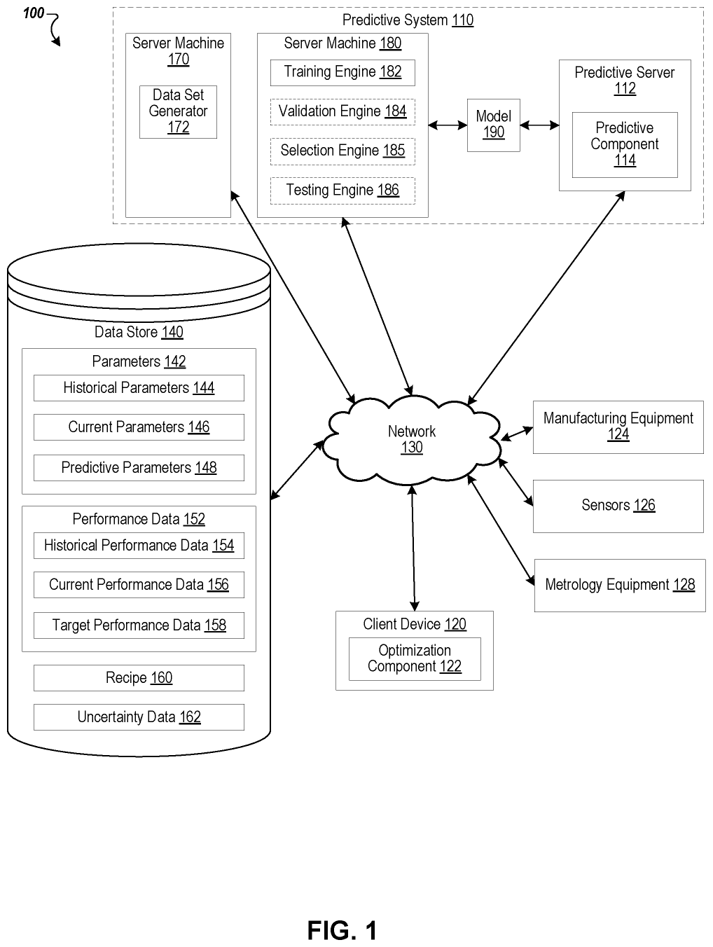

FIG. 1 is a block diagram illustrating an exemplary system 100 (exemplary system architecture), according to certain embodiments. The system 100 includes a client device 120, manufacturing equipment 124, sensors 126, metrology equipment 128, a predictive server 112, and a data store 140. In some embodiments, the predictive server 112 is part of a predictive system 110. In some embodiments, the predictive system 110 further includes server machines 170 and 180.

In some embodiments, one or more of the client device 120, manufacturing equipment 124, sensors 126, metrology equipment 128, predictive server 112, data store 140, server machine 170, and/or server machine 180 are coupled to each other via a network 130 for generating predictive data (e.g., predictive parameters 148 to be used to generate substrates having target performance data 158) to perform recipe optimization (e.g., optimization of a recipe 160). In some embodiments, network 130 is a public network that provides client device 120 with access to the predictive server 112, data store 140, and other publically available computing devices. In some embodiments, network 130 is a private network that provides client device 120 access to manufacturing equipment 124, sensors 126, metrology equipment 128, data store 140, and other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the client device 120 includes a computing device such as Personal Computers (PCs), laptops, mobile phones, smart phones, tablet computers, netbook computers, etc. In some embodiments, the client device 120 includes an optimization component 122. In some embodiments, the optimization component 122 may also be included in the predictive system 110 (e.g., machine learning processing system). In some embodiments, the optimization component 122 is alternatively included in the predictive system 110 (e.g., instead of being included in client device 120). Client device 120 includes an operating system that allows users to one or more of consolidate, generate, view, or edit data (e.g., recipe 160, target performance data 158, etc.), provide directives to the predictive system 110 (e.g., machine learning processing system), etc.

In some embodiments, optimization component 122 receives user input (e.g., via a Graphical User Interface (GUI) displayed via the client device 120) of an indication associated with a recipe 160 (e.g., target performance data 158). In some embodiments, the optimization component 122 transmits the indication to the predictive system 110, receives predictive data (e.g., predictive parameters 148) from the predictive system 110, determines a corrective action (e.g., optimization of the recipe 160) based on the predictive data, and causes the corrective action to be implemented. In some embodiments, the optimization component 122 obtains performance data 152 (e.g., target performance data 158) associated with a recipe 160 (e.g., from data store 140, etc.) and provides the performance data 152 to the predictive system 110. In some embodiments, the optimization component 122 stores performance data 152 (e.g., target performance data 158) in the data store 140 and the predictive server 112 retrieves the performance data 152 from the data store 140. In some embodiments, the predictive server 112 stores output (e.g., predictive parameters 148) of the trained machine learning model 190 in the data store 140 and the client device 120 retrieves the output from the data store 140. In some embodiments, the optimization component 122 receives an indication of an updated recipe 160 (e.g., based on predictive parameters 148) from the predictive system 110 and causes the recipe 160 to be implemented.

In some embodiments, the predictive parameters 148 are associated with updates to a recipe 160. In some embodiments, the predictive parameters 148 are associated with a corrective action. In some embodiments, a corrective action is associated with one or more of Computational Process Control (CPC), Statistical Process Control (SPC) (e.g., SPC to compare to a graph of 3-sigma, etc.), Advanced Process Control (APC), model-based process control, preventative operative maintenance, design optimization, updating of manufacturing parameters, feedback control, machine learning modification, or the like. In some embodiments, the corrective action includes updating parameters of a recipe 160. In some embodiments, the corrective action includes providing an alert (e.g., an alarm to not use the recipe 160 or the manufacturing equipment 124 if the predictive parameters 148 indicates a predicted abnormality, such as an uncertainty of producing a target having the target performance data 158, such as an abnormality of the product). In some embodiments, the corrective action includes providing feedback control (e.g., modifying the recipe 160 responsive to the predictive parameters 148 indicating a predicted abnormality). In some embodiments, the corrective action includes providing machine learning (e.g., causing modification of one or more parameters of production of substrates based on the predictive parameters 148).

In some embodiments, the predictive server 112, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 includes a predictive component 114. In some embodiments, the predictive component 114 receives target performance data 158 (e.g., receive from the client device 120, retrieve from the data store 140) and generates predictive data (e.g., predictive parameters 148) for optimizing the recipe 160. In some embodiments, the predictive component 114 uses one or more trained machine learning models 190 to determine the predictive data for recipe optimization. In some embodiments, trained machine learning model 190 is trained using historical parameters 144 and historical performance data 154.

In some embodiments, the predictive system 110 (e.g., predictive server 112, predictive component 114) generates predictive parameters 148 using supervised machine learning (e.g., supervised data set, historical parameters 144 labeled with historical performance data 154, etc.). In some embodiments, the predictive system 110 generates predictive parameters 148 using semi-supervised learning (e.g., semi-supervised data set, performance data 152 is a predictive percentage, etc.). In some embodiments, the predictive system 110 generates predictive parameters 148 using unsupervised machine learning (e.g., unsupervised data set, clustering, clustering based on historical parameters 144, etc.).

In some embodiments, the manufacturing equipment 124 (e.g., cluster tool) is part of a substrate processing system (e.g., integrated processing system). The manufacturing equipment 124 includes one or more of a controller, an enclosure system (e.g., substrate carrier, front opening unified pod (FOUP), autoteach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers, a robot arm (e.g., disposed in the transfer chamber, disposed in the front interface, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device is disposed in the factory interface to align the content. The load lock and the processing chambers mount to the transfer chamber and a robot arm disposed in the transfer chamber is to transfer content (e.g., substrates, process kit rings, carriers, validation wafer, etc.) between the load lock, the processing chambers, and the transfer chamber. In some embodiments, the manufacturing equipment 124 includes components of substrate processing systems. In some embodiments, the parameters 142 include parameters of processes performed by components of the manufacturing equipment 124 (e.g., etching, heating, cooling, transferring, processing, flowing, etc.).

In some embodiments, the sensors 126 provide parameters 142 associated with manufacturing equipment 124. In some embodiments, the sensors 126 provide sensor values (e.g., historical sensor values, current sensor values). In some embodiments, the sensors 126 include one or more of a pressure sensor, a temperature sensor, a flow rate sensor, a spectroscopy sensor, and/or the like. In some embodiments, the parameters are used for equipment health and/or product health (e.g., product quality). In some embodiments, the parameters 142 are received over a period of time.

In some embodiments, sensors 126 provide parameters 142 such as values of one or more of leak rate, temperature, pressure, flow rate (e.g., gas flow), pumping efficiency, spacing (SP), High Frequency Radio Frequency (HFRF), electrical current, power, voltage, and/or the like. In some embodiments, parameters 142 are associated with or indicative of manufacturing parameters such as hardware parameters (e.g., settings or components, such as size, type, etc., of the manufacturing equipment 124) or process parameters of the manufacturing equipment. In some embodiments, parameters 142 are provided while the manufacturing equipment 124 performs manufacturing processes (e.g., equipment readings when processing products or components), before the manufacturing equipment 124 performs manufacturing processes, and/or after the manufacturing equipment 124 performs manufacturing processes. In some embodiments, the parameters 142 are provided while the manufacturing equipment 124 provides a sealed environment (e.g., the diffusion bonding chamber, substrate processing system, and/or processing chamber are closed).

In some embodiments, the parameters 142 (e.g., historical parameters 144, current parameters 146, etc.) are processed (e.g., by the client device 120 and/or by the predictive server 112). In some embodiments, processing of the parameters 142 includes generating features. In some embodiments, the features are a pattern in the parameters 142 (e.g., slope, width, height, peak, etc.) or a combination of values from the parameters 142 (e.g., power derived from voltage and current, etc.). In some embodiments, the parameters 142 includes features that are used by the predictive component 114 for obtaining predictive parameters 148 for optimization of recipe 160.

In some embodiments, the metrology equipment 128 (e.g., imaging equipment, spectroscopy equipment, ellipsometry equipment, etc.) is used to determine metrology data (e.g., inspection data, image data, spectroscopy data, ellipsometry data, material compositional, optical, or structural data, etc.) corresponding to substrates produced by the manufacturing equipment 124 (e.g., substrate processing equipment). In some examples, after the manufacturing equipment 124 processes substrates, the metrology equipment 128 is used to inspect portions (e.g., layers) of the substrates. In some embodiments, the metrology equipment 128 performs scanning acoustic microscopy (SAM), ultrasonic inspection, x-ray inspection, and/or computed tomography (CT) inspection. In some examples, after the manufacturing equipment 124 deposits one or more layers on a substrate, the metrology equipment 128 is used to determine quality of the processed substrate (e.g., thicknesses of the layers, uniformity of the layers, interlayer spacing of the layer, and/or the like). In some embodiments, the metrology equipment 128 includes an imaging device (e.g., SAM equipment, ultrasonic equipment, x-ray equipment, CT equipment, and/or the like).

In some embodiments, the data store 140 is a memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of parameters 142, performance data 152, recipe 160, and/or uncertainty data 162 (e.g., uncertainty of model 190, uncertainty value, range of possible performance data 152 or parameters 142 determined by model 190, etc.).

Parameters 142 include historical parameters 144 (e.g., historical recipe parameters), current parameters 146 (e.g., current recipe parameters), and predictive parameters 148 (e.g., predictive recipe parameters). In some embodiments, parameters 142 (e.g., recipe parameters) may include additional attributes and may be hash key encoded. In some embodiments, the parameters 142 include one or more of a pressure data, a pressure range, temperature data, temperature range, flow rate data, power data, comparison parameters for comparing inspection data with threshold data, threshold data, cooling rate data, cooling rate range, and/or the like. In some embodiments, the parameters 142 include sensor data from sensors 126.

Performance data 152 includes historical performance data 154, current performance data 156, and target performance data 158. In some examples, the performance data 152 is indicative of whether a substrate is properly designed, properly produced, and/or properly functioning. In some embodiments, at least a portion of the performance data 152 is associated with a quality of substrates produced by the manufacturing equipment 124. In some embodiments, at least a portion of the performance data 152 is based on metrology data from the metrology equipment 128 (e.g., historical performance data 154 includes metrology data indicating properly processed substrates, property data of substrates, yield, etc.). In some embodiments, at least a portion of the performance data 152 is based on inspection of the substrates (e.g., current performance data 156 based on actual inspection). In some embodiments, the performance data 152 includes an indication of an absolute value (e.g., inspection data of the bond interfaces indicates missing the threshold data by a calculated value, deformation value misses the threshold deformation value by a calculated value) or a relative value (e.g., inspection data of the bond interfaces indicates missing the threshold data by 5%, deformation misses threshold deformation by 5%). In some embodiments, the performance data 152 is indicative of meeting a threshold amount of error (e.g., at least 5% error in production, at least 5% error in flow, at least 5% error in deformation, specification limit).

In some embodiments, the client device 120 provides performance data 152 (e.g., product data). In some examples, the client device 120 provides (e.g., based on user input) performance data 152 that indicates an abnormality in products (e.g., defective products). In some embodiments, the performance data 152 includes an amount of products that have been produced that were normal or abnormal (e.g., 98% normal products). In some embodiments, the performance data 152 indicates an amount of products that are being produced that are predicted as normal or abnormal. In some embodiments, the performance data 152 includes one or more of yield a previous batch of products, average yield, predicted yield, predicted amount of defective or non-defective product, or the like. In some examples, responsive to yield on a first batch of product being 98% (e.g., 98% of the products were normal and 2% were abnormal), the client device 120 provides performance data 152 indicating that the upcoming batch of products is to have a yield of 98%.

In some embodiments, historical data may be one or more prior DOEs. In some embodiments, historical data may include one or more prior DOEs. In some embodiments, historical data includes one or more of historical parameters 144 and/or historical performance data 154 (e.g., at least a portion for training the machine learning model 190). Current data includes one or more of current parameters 146 and/or current performance data 156 (e.g., at least a portion to be input into the trained machine learning model 190 subsequent to training the model 190 using the historical data). In some embodiments, the current data is used for retraining the trained machine learning model 190.

In some embodiments, the predictive parameters 148 are to be used by manufacturing equipment 124 to produce substrates that have the target performance data 158. In some embodiments, the uncertainty data 162 (e.g., in any form, such as from an acquisition function) is indicative of whether a predicted target response value (e.g., of the model 190 for one or more parameters 142) is sufficiently credible to be useful. That is if the predicted target response value, or a derived value from the predicted target response value, is greater than a threshold value, the predicted target response value may not have sufficient credibility to be trustworthy. In some embodiments, the predictive parameters 148 are associated with one or more of predicted parameters to produce substrates of target performance data 158 and/or predicted sensor data (e.g., virtual sensor data of the manufacturing equipment 124 to produce substrates having the target performance data 158). In some embodiments, the uncertainty data includes historical learning and prior and posterior probability distributions of parameters to facilitate future learning.

Performing metrology on products to determine incorrectly produced components (e.g., bonded metal plate structures) is costly in terms of time used, metrology equipment 128 used, energy consumed, bandwidth used to send the metrology data, processor overhead to process the metrology data, etc. By providing target performance data 158 to model 190 and receiving predictive parameters 148 from the model 190 for producing substrates that meet the target performance data 158, system 100 has the technical advantage of avoiding the costly process of using metrology equipment 128 and discarding substrates that do not meet target performance data 158.

Performing manufacturing processes that result in defective products is costly in time, energy, products, components, manufacturing equipment 124, the cost of identifying the component causing the defective products, producing a new component, and discarding the old component, etc. By providing target performance data 158 to model 190, receiving predictive parameters 148 from the model 190, and performing optimization of recipe 160 based on the predictive parameters 148, system 100 has the technical advantage of avoiding the cost of producing, identifying, and discarding defective substrates.

In some embodiments, manufacturing parameters are suboptimal (e.g., incorrectly calibrated, etc.) for producing product which has costly results of increased resource (e.g., energy, coolant, gases, etc.) consumption, increased amount of time to produce the products, increased component failure, increased amounts of defective products, etc. By providing target performance data 158 to model 190, receiving predictive parameters 148 from the model 190, and performing optimization of recipe 160 based on the predictive parameters 148, system 100 has the technical advantage of using optimal manufacturing parameters to avoid costly results of suboptimal manufacturing parameters.

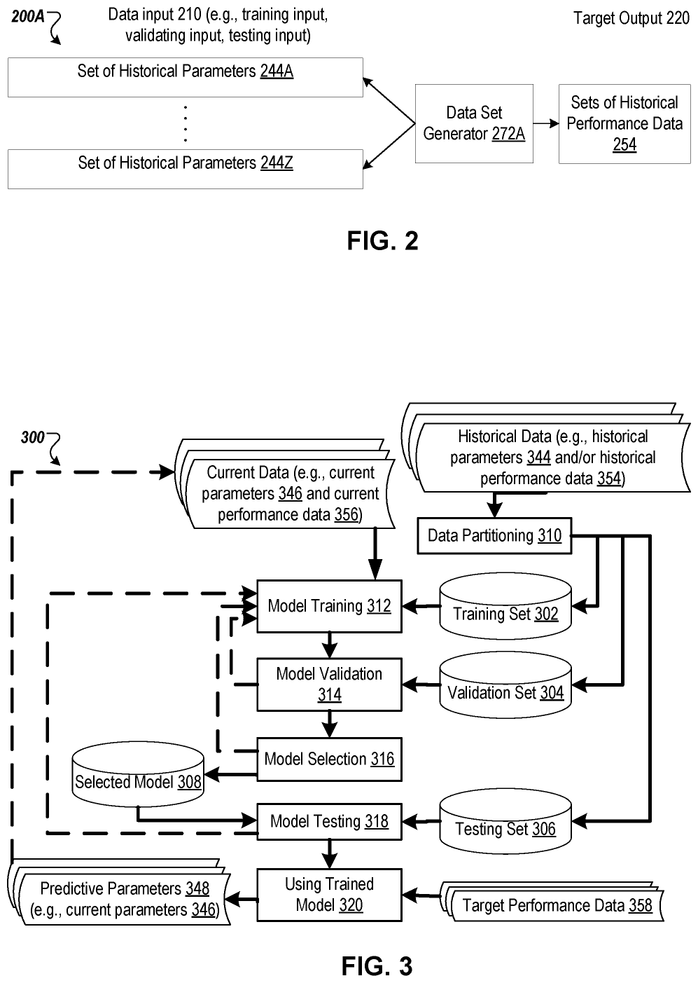

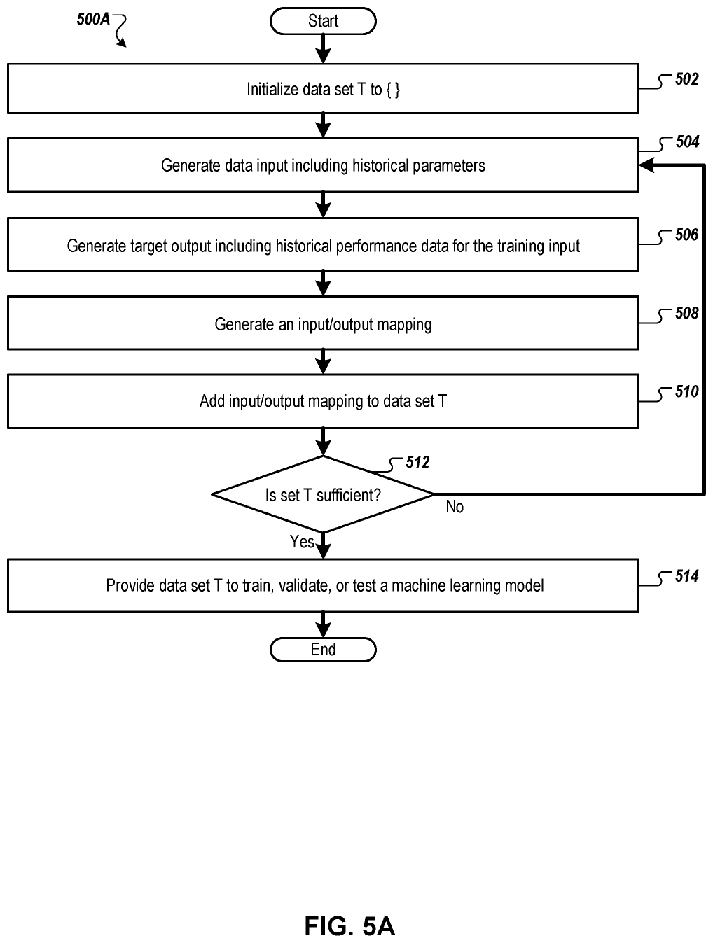

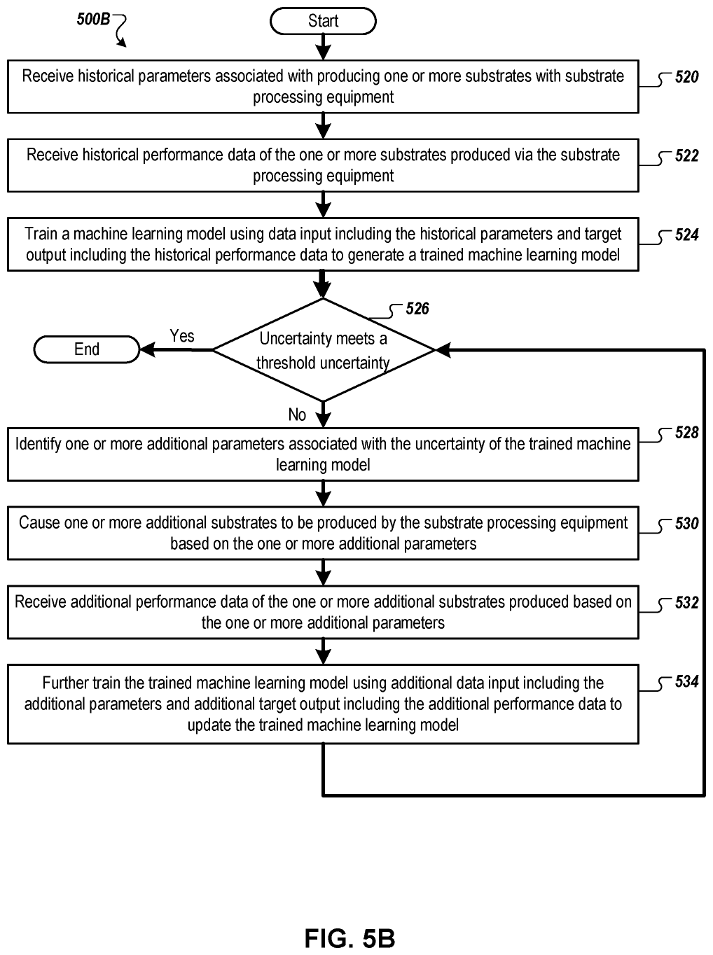

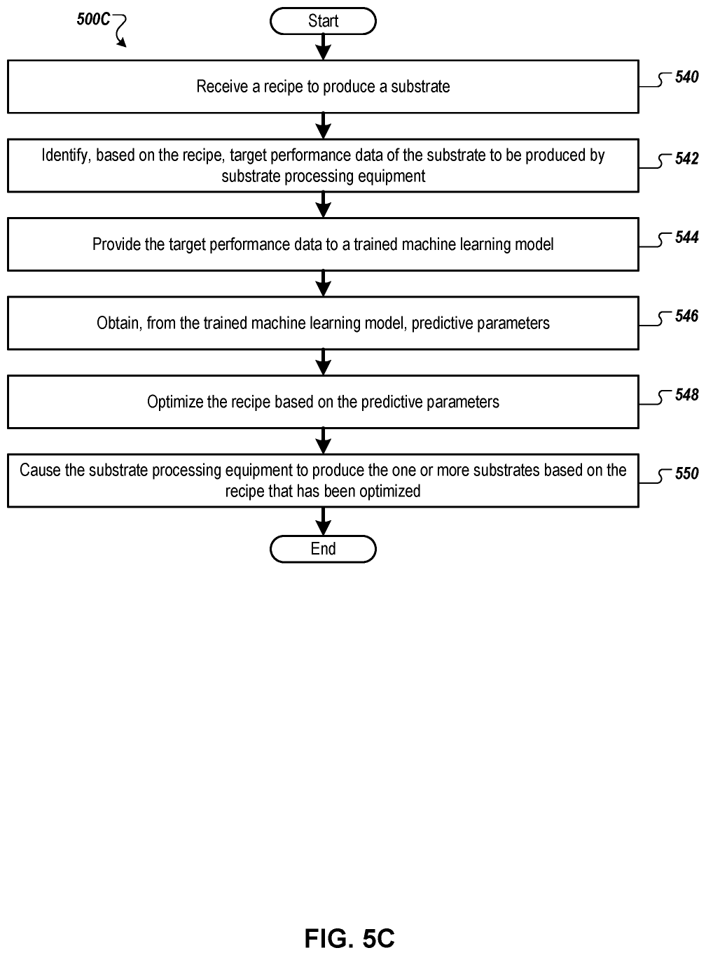

In some embodiments, predictive system 110 further includes server machine 170 and server machine 180. Server machine 170 includes a data set generator 172 that is capable of generating data sets (e.g., a set of data inputs and a set of target outputs) to train, validate, and/or test a machine learning model(s) 190. The data set generator has functions of data gathering, compilation, reduction, and/or partitioning to put the data in a form for machine learning. In some embodiments (e.g., for small datasets), partitioning (e.g., explicit partitioning) for post-training validation is not used. Repeated cross-validation (e.g. 5-fold cross-validation, leave-one-out-cross-validation) may be used during training where a given dataset is in-effect repeatedly partitioned into different training and validation sets during training. A model (e.g., the best model, the model with the highest accuracy, etc.) is chosen from vectors of models over automatically-separated combinatoric subsets. In some embodiments, the data set generator 172 may explicitly partition the historical data (e.g., historical parameters 144 and corresponding historical performance data 154) into a training set (e.g., sixty percent of the historical data), a validating set (e.g., twenty percent of the historical data), and a testing set (e.g., twenty percent of the historical data). In this embodiment, some operations of data set generator 172 are described in detail below with respect to FIGS. 2 and 5A. In some embodiments, the predictive system 110 (e.g., via predictive component 114) generates multiple sets of features (e.g., training features). In some examples a first set of features corresponds to a first set of types of parameters (e.g., from a first set of sensors, first combination of values from first set of sensors, first patterns in the values from the first set of sensors) that correspond to each of the data sets (e.g., training set, validation set, and testing set) and a second set of features correspond to a second set of types of parameters (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 is capable of training a machine learning model 190 using one or more sets of features associated with the training set from data set generator 172. In some embodiments, the training engine 182 generates multiple trained machine learning models 190, where each trained machine learning model 190 corresponds to a distinct set of parameters of the training set (e.g., recipe parameters, process parameters) and corresponding responses (e.g., performance data). In some embodiments, multiple models are trained on the same parameters with distinct targets for the purpose of modeling multiple effects. In some examples, a first trained machine learning model was trained using all parameters and processes of a recipe (e.g., Processes 1-5), a second trained machine learning model was trained using a first subset of the parameters (e.g., Process 2: parameters 1, 2, and 4), and a third trained machine learning model was trained using a second subset of the parameters (e.g., Process 3: parameters 1, 3, 4, and 5) that partially overlaps the first subset of features.

The validation engine 184 is capable of validating a trained machine learning model 190 using a corresponding set of features of the validation set from data set generator 172. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 evaluates and flags (e.g., to be discarded) trained machine learning models 190 that have an accuracy that does not meet a threshold accuracy. In some embodiments, the selection engine 185 is capable of selecting one or more trained machine learning models 190 that have an accuracy that meets a threshold accuracy. In some embodiments, the selection engine 185 is capable of selecting the trained machine learning model 190 that has the highest accuracy of the trained machine learning models 190.

The testing engine 186 is capable of testing a trained machine learning model 190 using a corresponding set of features of a testing set from data set generator 172. For example, a first trained machine learning model 190 that was trained using a first set of features of the training set is tested using the first set of features of the testing set. The testing engine 186 determines a trained machine learning model 190 that has the highest accuracy of all of the trained machine learning models based on the testing sets.

In some embodiments, the machine learning model 190 (e.g., used for classification) refers to the model artifact that is created by the training engine 182 using a training set that includes data inputs and corresponding target outputs (e.g. correctly classifies a condition or ordinal level for respective training inputs). Patterns in the data sets can be found that map the data input to the target output (the correct classification or level), and the machine learning model 190 is provided mappings that captures these patterns. In some embodiments, the machine learning model 190 uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. Non probabilistic methods may also be used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model 190 is a multi-variate analysis (MVA) regression model.

Predictive component 114 provides target performance data 158 (e.g., as output) to the trained machine learning model 190 and runs the trained machine learning model 190 (e.g., on the output input to obtain one or more inputs). The predictive component 114 is capable of determining (e.g., extracting) predictive parameters 148 (e.g., predictive recipe parameters) from (e.g., the input) of the trained machine learning model 190 and determines (e.g., extract) uncertainty data (e.g., determines uncertainty data 162) that indicates a level of credibility that the predictive parameters 148 produce substrates of target performance data 158 within an interval. In some embodiments, the predictive component 114 or optimization component 122 use the uncertainty data (e.g., uncertainty function or acquisition function derived from uncertainty function) to decide whether to use the predictive parameters 148 (e.g., predictive recipe parameters) to optimize the recipe 160 or whether to further train the model 190.

The uncertainty data (e.g., uncertainty data 162) includes or indicates an interval and most-likely value corresponding to the training target that the predictive parameters 148 (e.g., predictive recipe parameters) correspond to the target performance data 158 (e.g., substrates produced based on the predictive parameters would meet the target performance data 158). In one example, the level of an uncertainty-based acquisition function (e.g., uncertainty data 162) is a real number between 0 and 1 inclusive, where 0 indicates no credibility that the predictive parameters 148 corresponds to the target performance data 158 and 1 indicates absolute credibility that the predictive parameters 148 correspond to the target performance data 158. In some embodiments, the system 100 uses predictive system 110 to determine predictive parameters 148 instead of processing substrates using parameters 142 and using the metrology equipment 128 to determine whether the parameters 142 provide the target performance data 158. In some embodiments, responsive to the uncertainty data indicating a level of credibility that is below a threshold level, the system 100 causes processing of substrates and causes the metrology equipment 128 to generate the current performance data 156. Responsive to the confidence data indicating a level of credibility below a threshold level for a predetermined number of instances (e.g., percentage of instances, frequency of instances, total number of instances, etc.) the predictive component 114 causes the trained machine learning model 190 to be re-trained or further trained (e.g., based on the current parameters 146 and current performance data 156, etc.).

For purpose of illustration, rather than limitation, aspects of the disclosure describe the training of one or more machine learning models 190 using historical data (i.e. prior data) (e.g., historical parameters 144 and historical performance data 154) and providing target performance data 158 into the one or more trained probabilistic machine learning models 190 to determine predictive parameters 148. In other implementations, a heuristic model or rule-based model is used to determine predictive parameters 148 (e.g., without using a trained machine learning model). In other implementations non-probabilistic machine learning models may be used. Predictive component 114 monitors historical parameters 144 and historical performance data 154. In some embodiments, any of the information described with respect to data inputs 210 of FIG. 2 are monitored or otherwise used in the heuristic or rule-based model.

In some embodiments, the functions of client device 120, predictive server 112, server machine 170, and server machine 180 are be provided by a fewer number of machines. For example, in some embodiments, server machines 170 and 180 are integrated into a single machine, while in some other embodiments, server machine 170, server machine 180, and predictive server 112 are integrated into a single machine. In some embodiments, client device 120 and predictive server 112 are integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 determines optimization of the recipe 160 based on the predictive parameters 148. In another example, client device 120 determines the predictive parameters 148 based on predictive data received from the trained machine learning model.

In addition, the functions of a particular component can be performed by different or multiple components operating together. In some embodiments, one or more of the predictive server 112, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of reducing uncertainty and generating predictive parameters 148 to perform an optimization of a recipe 160 for use in manufacturing facilities (e.g., substrate processing facilities), in some embodiments, the disclosure can also be generally applied to reducing uncertainty in producing products. Embodiments can be generally applied to reducing uncertainty (e.g., increasing credibility of a solution etc.) based on different types of data. Non-probabilistic methods may have a significant difference in the approach and solution (e.g. confidence intervals.)

FIG. 2 illustrates a data set generator 272 (e.g., data set generator 172 of FIG. 1) to create data sets for a machine learning model (e.g., model 190 of FIG. 1), according to certain embodiments. In some embodiments, data set generator 272 is part of server machine 170 of FIG. 1. The data sets generated by data set generator 272 of FIG. 2 may be used to train a machine learning model with adaptive updating (e.g., see FIG. 5B) to perform recipe optimization (e.g., see FIG. 5C).

Data set generator 272 (e.g., data set generator 172 of FIG. 1) creates data sets for a machine learning model (e.g., model 190 of FIG. 1). Data set generator 272 creates data sets using historical parameters 244 (e.g., historical parameters 144 of FIG. 1) and historical performance data 254 (e.g., historical performance data 154 of FIG. 1). System 200 of FIG. 2 shows data set generator 272, data inputs 210, and target output 220 (e.g., target data).

In some embodiments, data set generator 272 generates a data set (e.g., training set, validating set, testing set) that includes one or more data inputs 210 (e.g., training input, validating input, testing input) and one or more target outputs 220 that correspond to the data inputs 210. The data set also includes mapping data that maps the data inputs 210 to the target outputs 220. Data inputs 210 are also referred to as “features,” “attributes,” or information.” In some embodiments, data set generator 272 provides the data set to the training engine 182, validating engine 184, or testing engine 186, where the data set is used to train, validate, or test the machine learning model 190. Some embodiments of generating a training set are further described with respect to FIG. 5A.

In some embodiments, data set generator 272 generates the data input 210 and target output 220. In some embodiments, data inputs 210 include one or more sets of historical parameters 244. In some embodiments, historical parameters 244 include one or more of parameters from one or more types of sensors, combination of parameters from one or more types of sensors, patterns from parameters from one or more types of sensors, and/or the like.

In some embodiments, data set generator 272 generates a first data input corresponding to a first set of historical parameters 244A to train, validate, or test a first machine learning model and the data set generator 272 generates a second data input corresponding to a second set of historical parameters 244B to train, validate, or test a second machine learning model.

In some embodiments, the data set generator 272 discretizes (e.g., segments) one or more of the data input 210 or the target output 220 (e.g., to use in classification algorithms for regression problems). Discretization (e.g., segmentation via a sliding window) of the data input 210 or target output 220 transforms continuous values of variables into discrete values. In some embodiments, the discrete values for the data input 210 indicate discrete historical parameters 244 to obtain a target output 220 (e.g., discrete historical performance data 254).

Data inputs 210 and target outputs 220 to train, validate, or test a machine learning model include information for a particular facility (e.g., for a particular substrate manufacturing facility). In some examples, historical parameters 244 and historical performance data 254 are for the same manufacturing facility.

In some embodiments, the information used to train the machine learning model is from specific types of manufacturing equipment 124 of the manufacturing facility having specific characteristics and allow the trained machine learning model to determine outcomes for a specific group of manufacturing equipment 124 based on input for current parameters (e.g., current parameters 146) associated with one or more components sharing characteristics of the specific group. In some embodiments, the information used to train the machine learning model is for components from two or more manufacturing facilities and allows the trained machine learning model to determine outcomes for components based on input from one manufacturing facility.

In some embodiments, subsequent to generating a data set and training, validating, or testing a machine learning model 190 using the data set, the machine learning model 190 is further trained, validated, or tested (e.g., current performance data 156 of FIG. 1) or adjusted (e.g., adjusting weights associated with input data of the machine learning model 190, such as connection weights in a neural network).

FIG. 3 is a block diagram illustrating a system 300 for generating predictive data (e.g., predictive parameters 348, predictive parameters 148 of FIG. 1), according to certain embodiments. The system 300 is used to determine predictive parameters 348 via a trained machine learning model (e.g., model 190 of FIG. 1) to cause recipe optimization (e.g., for production of substrates with manufacturing equipment 124).

At block 310, the system 300 (e.g., predictive system 110 of FIG. 1) performs data partitioning (e.g., via data set generator 172 of server machine 170 of FIG. 1) of the historical data (e.g., historical parameters 344 and historical performance data 354 for model 190 of FIG. 1) to generate the training set 302, validation set 304, and testing set 306. In some examples, the training set is 60% of the historical data, the validation set is 20% of the historical data, and the testing set is 20% of the historical data. The system 300 generates a plurality of sets of features for each of the training set, the validation set, and the testing set. In some examples, if the historical data includes features derived from parameters from 20 sensors (e.g., sensors 126 of FIG. 1) and 100 products (e.g., products that each correspond to the parameters from the 20 sensors), a first set of features is sensors 1-10, a second set of features is sensors 11-20, the training set is products 1-60, the validation set is products 61-80, and the testing set is products 81-100. In this example, the first set of features of the training set would be parameters from sensors 1-10 for products 1-60.

At block 312, the system 300 performs model training (e.g., via training engine 182 of FIG. 1) using the training set 302. In some embodiments, the system 300 trains multiple models using multiple sets of features of the training set 302 (e.g., a first set of features of the training set 302, a second set of features of the training set 302, etc.). For example, system 300 trains a machine learning model to generate a first trained machine learning model using the first set of features in the training set (e.g., parameters from sensors 1-10 for products 1-60) and to generate a second trained machine learning model using the second set of features in the training set (e.g., parameters from sensors 11-20 for products 1-60). In some embodiments, the first trained machine learning model and the second trained machine learning model are combined to generate a third trained machine learning model (e.g., which is a better predictor than the first or the second trained machine learning model on its own in some embodiments). In some embodiments, sets of features used in comparing models overlap (e.g., first set of features being parameters from sensors 1-15 and second set of features being sensors 5-20). In some embodiments, hundreds of models are generated including models with various permutations of features and combinations of models.

At block 314, the system 300 performs model validation (e.g., via validation engine 184 of FIG. 1) using the validation set 304. The system 300 validates each of the trained models using a corresponding set of features of the validation set 304. For example, system 300 validates the first trained machine learning model using the first set of features in the validation set (e.g., parameters from sensors 1-10 for products 61-80) and the second trained machine learning model using the second set of features in the validation set (e.g., parameters from sensors 11-20 for products 61-80). In some embodiments, the system 300 validates hundreds of models (e.g., models with various permutations of features, combinations of models, etc.) generated at block 312. At block 314, the system 300 determines an accuracy of each of the one or more trained models (e.g., via model validation) and determines whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. The system 300 discards the trained machine learning models that have an accuracy that is below the threshold accuracy (e.g., based on the validation set).

At block 316, the system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow returns to block 312 where the system 300 performs model training using further refined training sets corresponding to further refined sets of features for determining a trained model that has the highest accuracy.

At block 318, the system 300 performs model testing (e.g., via testing engine 186 of FIG. 1) using the testing set 306 to test the selected model 308. The system 300 tests, using the first set of features in the testing set (e.g., parameters from sensors 1-10 for products 81-100), the first trained machine learning model to determine the first trained machine learning model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where the system 300 performs model training (e.g., retraining) using different training sets corresponding to different sets of features (e.g., parameters from different sensors). Responsive to determining that the selected model 308 has an accuracy that meets a threshold accuracy based on the testing set 306, flow continues to block 320. In at least block 312, the model learns patterns in the historical data to make predictions and in block 318, the system 300 applies the model on the remaining data (e.g., testing set 306) to test the predictions.

At block 320, system 300 uses the trained model (e.g., selected model 308) to receive target performance data 358 (e.g., target performance data 158 of FIG. 1) and determines (e.g., extracts), from the trained model, predictive data (e.g., predictive parameters 348, predictive parameters 148 of FIG. 1) to perform recipe optimization. In some embodiments, the current parameters 346 correspond to the same types of features in the historical parameters. In some embodiments, the current parameters 346 corresponds to a same type of features as a subset of the types of features in historical parameters that are used to train the selected model 308.

In some embodiments, current data is received. In some embodiments, current data includes current performance data 356 (e.g., current performance data 156 of FIG. 1) and/or current parameters 346 (e.g., predictive parameters 348 that were used to produce substrates). In some embodiments, the current data is received from metrology equipment (e.g., metrology equipment 128 of FIG. 1) or via user input. The model 308 is re-trained based on the current data. In some embodiments, a new model is trained based on the current performance data 356 and the current parameters 346.

In some embodiments, additional parameters associated with uncertainty of the trained machine learning model are identified, additional substrates are produced based on the additional parameters, additional performance data of the additional substrates is received, and one or more of blocks 310-320 are performed. In some embodiments, this is repeated based on the additional parameters and additional performance data until uncertainty of the trained machine learning model meets a threshold uncertainty.

In some embodiments, one or more of the blocks 310-320 occur in various orders and/or with other operations not presented and described herein. In some embodiments, one or more of blocks 310-320 are not be performed. For example, in some embodiments, one or more of data partitioning of block 310, model validation of block 314, model selection of block 316, and/or model testing of block 318 are not be performed.

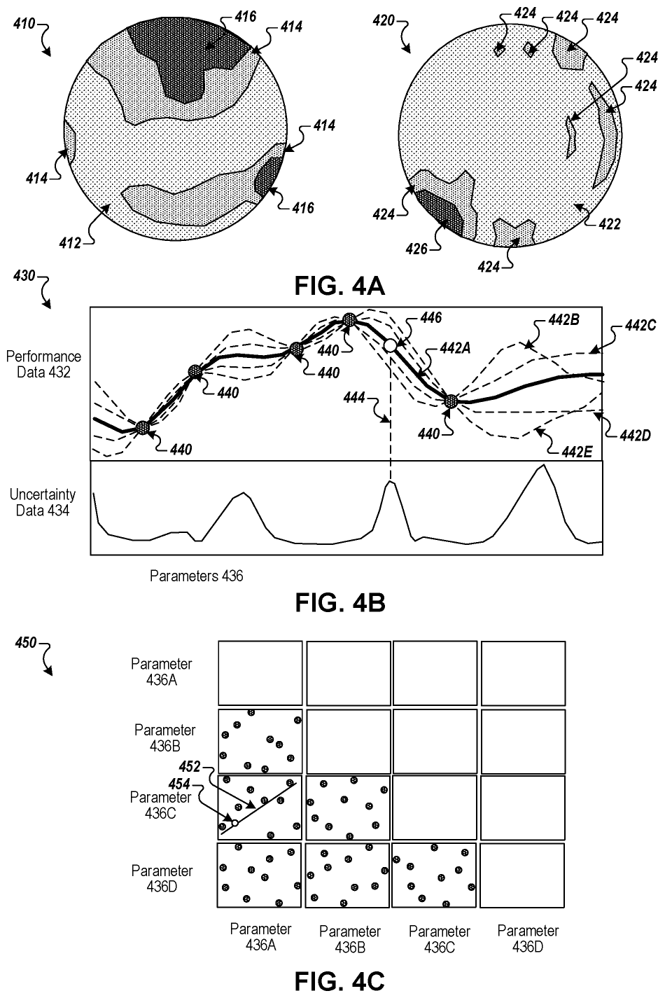

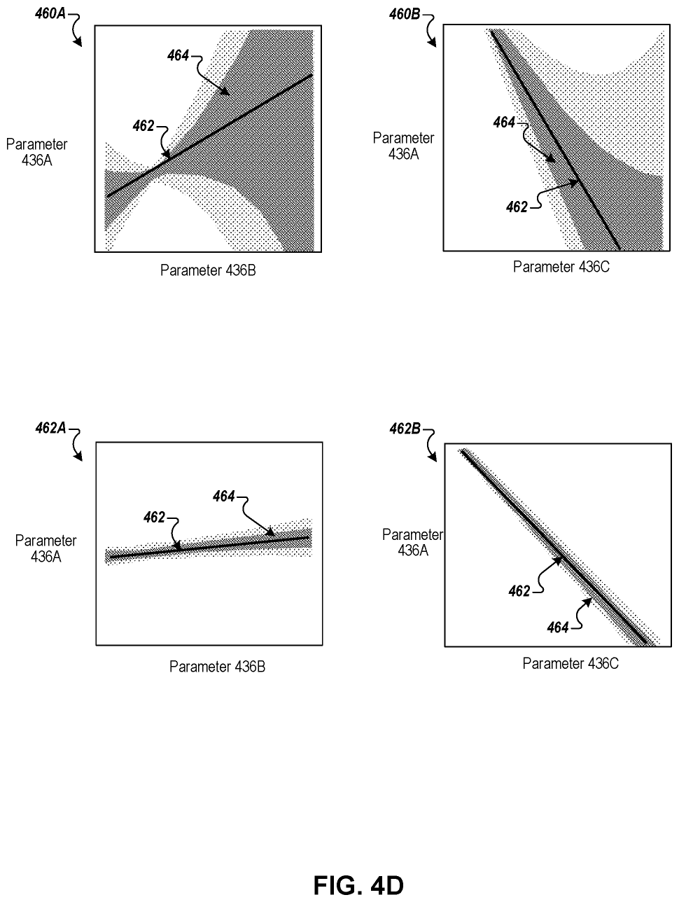

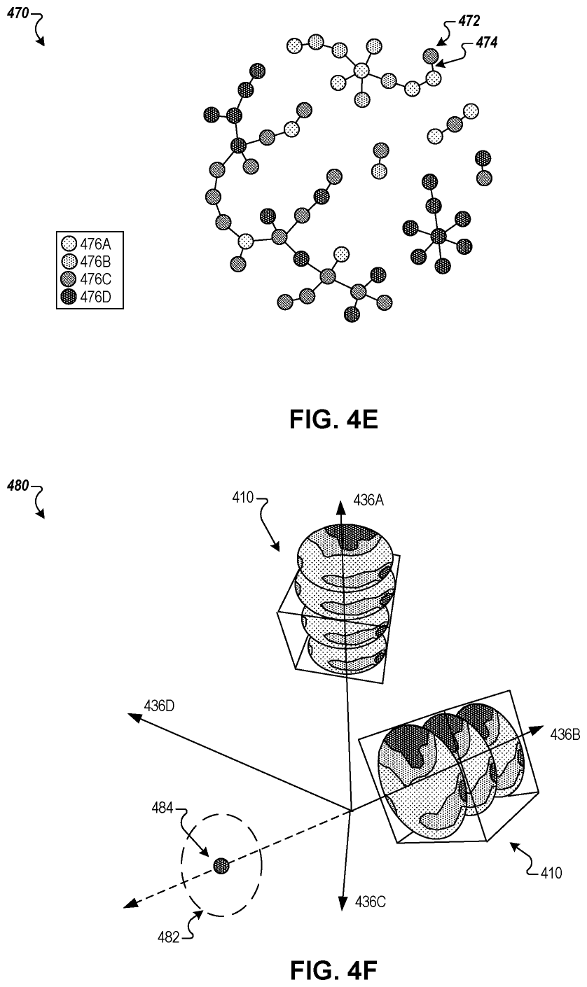

FIG. 4A illustrates performance data 410 (e.g., performance data 152 of FIG. 1) and uncertainty data 420 (e.g., uncertainty data 162 of FIG. 1) used in recipe optimization, according to certain embodiments. In some embodiments, performance data 410 is a GPR (or other Bayesian regression) response (e.g., the most likely value in a function of probability distributions) and uncertainty data (e.g., the uncertainty interval distribution or an acquisition function derived from this.) 420 is the GPR uncertainty. In some embodiments, performance data 410 is GPR or other Bayesian regression results from ellipsometric thin film thickness measurements over a substrate and uncertainty data 420 is corresponding substrate distribution of uncertainty. Local regions of highest uncertainty (e.g., portion 426) may correspond to data points where outliers were removed from the regression or where measurement sampling was insufficient. These results may be used as targets in modeling over recipe parameters.

In some embodiments, a machine learning model is trained with data input of historical parameters and target output of historical performance data (e.g., performance data 410) to generate a trained machine learning model. Additional parameters can be input into the trained machine learning model (e.g., the additional parameters may be different from historical parameters used to produce actual substrates for which historical performance data is available) and the trained machine learning model may output performance data 410 (e.g., predicted performance data) and uncertainty data 420 (e.g., a uncertainty level that the predicted performance data is sufficiently predictive to be useful).

The performance data 410 may be a comparison of measurement data to threshold data in terms of classification (e.g., comparing ordinal classes of thickness values to ordinal classes threshold thickness values, comparing classes flatness value to classes threshold flatness value). As shown in FIG. 4A, performance data 410 may include portion 412 that meets first threshold values (e.g., has flatness values closest to threshold flatness values, has thickness values closest to threshold thickness values), portion 414 that meets second threshold values (e.g., has flatness values further from threshold flatness values, has thickness values further from threshold thickness values), and portion 416 that meets third threshold values (e.g., has flatness values furthest from threshold flatness values, has thickness values furthest from threshold thickness values). In some embodiments, performance data 410 is predictive performance data for particular parameters.

Uncertainty data 420 (e.g., uncertainty data 162 of FIG. 1) may include portion 422 that meets first threshold uncertainty values (e.g., most certain that a substrate of performance data 410 would be produced by a set of parameters), portion 424 that meets second threshold uncertainty values (e.g., less certain that a substrate of performance data 410 would be produced by a set of parameters), and portion 426 that meets third threshold uncertainty values (e.g., least certain that a substrate of performance data 410 would be produced by a set of parameters).

Responsive to uncertainty data 420 not meeting a threshold uncertainty (e.g., exceeding a minimum uncertainty), additional parameters associated with the uncertainty data 420 may be identified and additional substrates may be produced by the substrate processing equipment based on the additional parameters. Additional performance data of the additional substrates produced based on the additional parameters may be received and the trained machine learning model may be further trained based on the additional parameters and the additional performance data. If the uncertainty data 420 of the further trained machine learning model does not meet a threshold uncertainty, the process is repeated until the uncertainty data 420 meets the threshold uncertainty.

FIG. 4B illustrates a plot 430 associated with recipe optimization, according to certain embodiments.

In using probabilistic methods, plot 430 is a representation of performance measurement data (e.g., points 440) and regression as probability functions. The dark line (e.g., line 442A) passing through points 440 illustrates the expectation or most-likely response function that will fit the data (e.g., points 440) together with functions that correspond to four random draws and which illustrate a range of possible responses. These functions are constrained at the data points 440 as there is no (or there is a small specified) predictive uncertainty at these points 440. Alternatively, the envelope which encloses the high probability density interval (HDI) of probable results (e.g., the 90% HDI) could be displayed. This methodology is general and may be used over various performance measurements and with different substrates and any parameters. For the specific wafer case illustrated in FIG. 4A, process parameters together with measurement locations are used as parameters (explanatory variables) in the regression. DOE process parameters and measurement data are used in model training. The HDI is a function over the full range of the data and may be used in a derived function sometimes referred to as acquisition function for the purpose of identifying regions in the DOE which have the highest uncertainty over the range as illustrated in uncertainty data 434 on plot 430. This type of function may be the basis for automated updating or adaptive DOE. New points may be selected to adaptively add to the DOE from the acquisition function. The process parameters at these points are used to produce and measure new wafers and then update the model.

By adding one or more points such as data point 446, which correspond to an uncertainty peak shown by connecting line 444, local uncertainty is minimized and the overall range of uncertainty is also reduced.

Responsive to the uncertainty data at line 444 and potentially an acquisition function, the additional parameters at line 444 are identified and additional substrates are produced based on additional parameters (e.g., the new recipe parameters). Additional performance data is received for the additional substrates. The additional parameters and additional performance data correspond to data point 446. After model updating with these data points, the uncertainty at 446 on plot 430 may be zero (or a specified measurement error) and global uncertainty is also reduced, as the range of possible function draws are effectively constrained by the new point. Further, points with a degree of correlation to this point may have reduced uncertainty as well. In some embodiments, DOE recipe parameters 436 are designed using space filling design (SFD) DOE. For each parameter, the DOE points may be plotted. Multiple parameters 436 can be plotted in different types of informative plots, such as shown in a bivariate pairs plot which illustrates a relatively uniform distribution of the DOE points in this space.

FIG. 4C illustrates plots 450 associated with a SFD DOE used in recipe optimization, according to certain embodiments. Plots 450 may be bivariate pairs plot that plots pairs of parameters 436 (e.g., of parameters 436 of FIG. 4B) as points. Each data point (e.g., data points in a space-filling design DOE) in plots 450 may correspond to a pair of parameters 436 common to all recipes. The bivariate line 452 (e.g., hypothetical bivariate line) might for example correspond to the function 442A of FIG. 4B. Data point 454 (e.g., augmented design point) corresponds to data point 446 of FIG. 4B. By adding data point 454, bivariate line 452 illustrates where the point is added to achieve greater certainty. Data points to be added may be associated with the most open region in a design.

FIG. 4D illustrates plots 460A-B and 462A-B, according to certain embodiments (e.g., in a multivariate Bayesian linear regression). Plot 460A shows parameter 436A (e.g., which may be a line CD) plotted against parameter 436B and plot 460B shows parameter 436A plotted against parameter 436C. Each plot 460A-B has a line 462 which represents the expected or most-likely result and uncertainty ‘highest density intervals’ HDIs which may indicate that solutions exist within a probability distribution than contains 95% or 80% of the posterior density (e.g., uncertainty portions 464 that are shaded). Responsive to the uncertainty portions 464 not meeting threshold uncertainty (e.g., through an acquisition function based on the HDI), additional parameters are identified (corresponding to plots 460A-B), additional substrates are produced based on the additional parameters, and additional performance data is received for the additional substrates. The additional parameters and additional performance data are used with the existing parameters and performance data that were used to generate plots 460A-B to generate plots 462A-B. Each plot 462A-B has a line 462 and smaller uncertainty portions 464 (e.g., that are shaded). Responsive to the uncertainty portions 464 not meeting threshold uncertainty, the process is repeated until the uncertainty portions 464 meet threshold uncertainty.

In some embodiments, by identifying parameters for plot 460A, producing additional substrates based on the parameters for plot 460A, and receiving additional performance data for the additional substrates, the parameters and additional performance data can be used to decrease the uncertainty represented in corresponding plots 462A and 462B. This action minimizes uncertainty at the location of the point insertion but will also reduce the uncertainty of correlated points and to an extent over the full range of the DOE.

FIG. 4E illustrates a plot 470 of data points 472 associated with recipe optimization, according to certain embodiments. In some embodiments, plot 470 is a force-directed acyclic graph of coupons over a DOE (e.g., small test substrates manufactured based on parameters) which illustrates a manner of clustering which retains relationships between the coupons. The inter-coupon similarity may be annotated with a key response (e.g., performance data) variable that may be shown in grouping and connectivity of similar coupons (e.g., data points 472 connected via lines 474).

Each of the data points 472 may correspond to parameters used to produce a substrate and performance data of the substrate. Groups of data points 472 are shown on plot 470 as being linked by one or more lines 474. To produce substrates and receive performance data of the substrates, one or more parameters for producing the substrates may be adjusted. In some embodiments, the lines 474 shown on plot 470 represent adjusting one or more parameters after determining a first data point 472 in order to determine a second data point 472. Conventionally, few parameters are adjusted in producing substrates which causes the data points 472 to not cover a wide range of available parameters and which may lead to producing a sub-optimal recipe.

As shown in FIG. 4E, different data points 472 are part of different clusters 476. In some embodiments, a cluster 476 and subclusters of cluster 476 are associated with ordinal categorical performance data of the substrate produced based on corresponding parameters meeting threshold performance data (e.g., very bad, flat, fair, bad, etc.).

In some embodiments, data points 472 are grouped based on similar parameters (e.g., substrates produced by relatively similar process parameters, data points 472 shown as connected by lines 474). In some embodiments, data points 472 are determined to have predicted performance data based on the group to which the data points 472 belong. For example, if performance data for one data point 472 of a group is known, other data points 472 of the same group may be predicted to have similar performance data. In some embodiments, this method of unsupervised machine learning is used to determine groups of data points 472. In some embodiments, performance data (e.g., metrology data) is measured for a subset of the data points 472 based on the groups (e.g., performance data for one or more data points 472 in each group is determined).

In some embodiments, each group of data points 472 (e.g., data points 472 linked by lines 474, data points 472 corresponding to slightly adjusting parameters to produce substrates) are part of the same cluster 476. In some embodiments, a group of data points 472 includes data points 472 that are part of different clusters 476.

In some embodiments, plot 470 can be used to determine whether a wide range of parameters has been used. In some examples, empty spaces in plot 470 are associated with uncertainty of what performance data (e.g., what cluster 476 of performance data) the parameters in the empty spaces correspond.

FIG. 4F illustrates a plot 480 associated with recipe optimization, according to certain embodiments. In some embodiments, FIG. 4F is an illustration of using a trained machine learning model to determine predicted parameters 484 corresponding to target performance data 482 (e.g., to optimize recipe parameters for etch variance).

Different axes of plot 480 may correspond to different parameters 436 (e.g., as individual or joint variants, a multi-variable plot). Data points on the plot may correspond to different performance data 410 for corresponding parameters 436. In some embodiments, parameters 436 and performance data 410 are used to train a machine learning model (e.g., plot 480), uncertainty of the trained machine learning model (e.g., plot 480) is determined, additional performance data is determined for additional parameters associated with the uncertainty, and the trained machine learning model (e.g., plot 480) is further trained based on the additional performance data and additional parameters. This continues until the uncertainty of the trained machine learning model (e.g., plot 480) meets a threshold uncertainty. Target performance data 482 for producing a substrate is determined (e.g., based on a recipe). The target performance data 482 is identified on the plot 480 and the corresponding parameters 436 on the plot 480 are the predicted parameters 484 to be used to generate a substrate having the target performance data 482.

FIGS. 5A-C are flow diagrams of methods 500A-C associated with recipe optimization according to certain embodiments. Methods 500A-C can be used for efficient process recipe optimization through machine learning, such as by optimizing etch recipes through machine learning, enabling convergence to an optimal recipe through Bayesian Optimization (e.g., faster convergence than conventional solutions), adaptive design, space filling design (SFD), Gaussian progress regression or Bayesian regression or classification or other probabilistic method previously mentioned including deep learning variants, process recipe (e.g., multi-operation process recipe) development, nanoscale fabrication technologies, etc.

In some embodiments, methods 500A-C are performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, methods 500A-C are performed, at least in part, by predictive system 110. In some embodiments, method 500A is performed, at least in part, by predictive system 110 (e.g., server machine 170 and data set generator 172 of FIG. 1, data set generator 272 of FIG. 2). In some embodiments, predictive system 110 uses method 500A to generate a data set to at least one of train, validate, or test a machine learning model. In some embodiments, method 500B is performed by server machine 180 (e.g., training engine 182, etc.). In some embodiments, method 500C is performed by predictive server 112 (e.g., predictive component 114). In some embodiments, method 500C is performed by client device 120 (e.g., optimization component 122). In some embodiments, a non-transitory storage medium stores instructions that when executed by a processing device (e.g., of predictive system 110, of server machine 180, of predictive server 112, etc.), cause the processing device to perform one or more of methods 500A-C.

For simplicity of explanation, methods 500A-C are depicted and described as a series of operations. However, operations in accordance with this disclosure can occur in various orders and/or concurrently and with other operations not presented and described herein. Furthermore, in some embodiments, not all illustrated operations are performed to implement methods 500A-C in accordance with the disclosed subject matter. In addition, those skilled in the art will understand and appreciate that methods 500A-C could alternatively be represented as a series of interrelated states via a state diagram or events.

Methods 500A-C can be used for substrate-based flows (e.g., processing substrates), coupon-based flows (e.g., processing coupons), and/or simulation-based flows in which a numerical simulation may be used to create data (e.g., to form an efficient surrogate from a DOE of relatively-few computationally expensive simulations.). Methods 500A-C may be used in the same manner as in physical DOE experimentation with complex simulations. These complex simulations which may include time-consuming and computationally-expensive plasma and/or chemistry simulations or technology computer aided design (TCAD) simulations over a parameter-space DOE to minimize the number of simulation experiments (e.g., plasma and chemistry or physical structure evolution) and adaptively add DOE points (e.g., additional simulations) where needed. In some embodiments, separate machine learning models may be combined to achieve unique responses not available to either.

Methods 500A-C can be used to improve multi-operation process substrate etch uniformity, to improve self-aligned multi-patterning spacer shape, to improve fundamental cause-effect understanding, and/or the like.

In substrate-based recipe optimization, a given DOE may be augmented through Bayesian-derived machine learning. In coupon-based recipe optimization, a given DOE may be augmented through Bayesian-derived machine learning. Multiple models with different responses (e.g., performance data) may be combined to provide a combined quality score. Response data (e.g., performance data) for substrate-based and/or coupon-based recipe optimization used for training may include ellipsometry, cross-sectional scanning electron microscope (xSEM) metrology, critical dimension SEM (CD-SEM) metrology, Transmission Electron Microscopy (TEM), Optical Emission Spectroscopy (OES) or metrology, structure, or material information extracted from these. In simulation-based recipe optimization, a given DOE may be augmented through Bayesian-derived machine learning to achieve a Bayesian optimization cycle. Simulation response data (e.g., performance data) for training may include plasma simulation, thermal simulation, gas flow simulation, electromagnetic simulation, etc. Both substrate machine learning results (e.g., performance data of processed substrates) and simulation-based machine learning results (e.g., simulation performance data) may be combined to show mixed mode results and enable interpretation of latent chamber effects contributing to substrate non-uniformity or patterning effects. A data system that enables this as well as data mining, analytics, and machine learning may include a dataframe which combines any number of multi-operation recipes into a dataframe. A-priori data may be used to help define a new DOE or to incorporate into analysis. In some embodiments, methods 500A-C may provide robustness of interferences, provide basis for augmenting the SFD DOE, and is a closed loop method for efficient systematic SFD and modeling until acceptable convergence. In some embodiments, in one or more of methods 500A-C, outliers or other anomalies or data which does not contribute significantly to the model accuracy may be removed or disregarded.

FIG. 5A is a flow diagram of a method 500A for generating a data set for a machine learning model for generating predictive data (e.g., predictive parameters 148 of FIG. 1), according to certain embodiments.

Referring to FIG. 5A, in some embodiments, at block 502 the processing logic implementing method 500A initializes a training set T to an empty set.

At block 504, processing logic generates first data input (e.g., first training input, first validating input) that includes parameters (e.g., historical parameters 144 of FIG. 1, historical parameters 244 of FIG. 2, recipes, etc.). In some embodiments, the first data input includes a first set of features for types of parameters and a second data input includes a second set of features for types of parameters (e.g., as described with respect to FIG. 2).

At block 506, processing logic generates a first target output for one or more of the data inputs (e.g., first data input). In some embodiments, the first target output is historical performance data (e.g., historical performance data 154 of FIG. 1, historical performance data 254 of FIG. 2).

At block 508, processing logic optionally generates mapping data that is indicative of an input/output mapping. The input/output mapping (or mapping data) refers to the data input (e.g., one or more of the data inputs described herein), the target output for the data input (e.g., where the target output identifies historical performance data 154), and an association between the data input(s) and the target output.

At block 510, processing logic adds the mapping data generated at block 508 to data set T.

At block 512, processing logic branches based on whether data set T is sufficient for at least one of training, validating, and/or testing machine learning model 190 (e.g., uncertainty of the trained machine learning model meets a threshold uncertainty). If so, execution proceeds to block 514, otherwise, execution continues back to block 504. It should be noted that in some embodiments, the sufficiency of data set T is determined based simply on the number of input/output mappings in the data set, while in some other implementations, the sufficiency of data set T is determined based on one or more other criteria (e.g., a measure of diversity of the data examples, accuracy, etc.) in addition to, or instead of, the number of input/output mappings.

At block 514, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T.

After block 514, machine learning model (e.g., machine learning model 190) can be at least one of trained using training engine 182 of server machine 180, validated using validating engine 184 of server machine 180, or tested using testing engine 186 of server machine 180. The trained machine learning model is implemented by predictive component 114 (of predictive server 112) to generate predictive data (e.g., predictive parameters 148) for recipe optimization.

FIG. 5B is a method for training a machine learning model (e.g., model 190 of FIG. 1) for determining predictive data (e.g., predictive parameters 148 of FIG. 1) to perform recipe optimization.

Referring to FIG. 5B, at block 520 of method 500B, the processing logic receives sets of historical parameters (e.g., historical parameters 144 of FIG. 1, historical recipe parameters, historical recipes that include the historical parameters) and/or historical recipes associated with producing one or more substrates with substrate processing equipment. The historical parameters may be from processes of one or more recipes.

In some embodiments, the historical parameters used to define new DOEs and to process substrates (e.g. wafers or coupons) are based on a-priori knowledge including that of domain experts, unsupervised learning or other analytics, data mining, experimental design (e.g., DOE including SFD), TCAD, or other numerical physics/chemistry simulation, production yield data and/or modeling, and/or the like. In some embodiments, the processing logic receives the historical parameters and creates recipes which may be formatted for and uploaded to the specific processing equipment to facilitate execution of the one or more recipes and/or to facilitate the relevant measurement of the target/performance data. Substrates may be produced, substrates may be measured, and the measurement data may be stored in the standard locations described.

At block 522, the processing logic receives sets of historical performance data (e.g., historical performance data 154 of FIG. 1) of the one or more substrates produced by the substrate processing equipment using the historical parameters. Each of the sets of the historical performance data corresponds to a respective set of historical parameters of the sets of historical parameters. In some embodiments, the historical performance data is indicative of thickness values of one or more layers of the substrates, flatness of one or more layers of the substrates, CD values, shape parameter values, shape description values, material property values, metrology values, sensor measurement values, etc. In some embodiments, the historical performance data is indicative of an absolute value or relative value. Performance data in general may be continuous or categorical (e.g., categorical data may be ordinal).

The historical performance data of the substrates may be associated with diverse metrology, materials, and other measurements including one or more of optical emission spectrometry (OES), ellipsometry, cross-section SEM (xSEM) metrology, CD-SEM metrology, transmission electron microscopy (TEM), TCAD or plasma physics simulation output, atomic force microscopy (AFM), electrical measurements, etc.

In some embodiments, data including historical parameters over any number of process steps within a recipe and/or historical performance data is gathered, managed, and compiled into a format (e.g., dataframe object) to facilitate data methods and processes, such as data mining, analytics, and machine learning. In some examples, the processing logic applies a dataframe format to the historical parameters and historical performance data and performs GPR, Bayesian regression or classification, or Bayesian Optimization (e.g., trains a machine learning model) based on the historical parameters and historical performance data in dataframe format. In some embodiments, the dataframe may be stored in a database representation.

In some embodiments, integrated adaptive DOE and machine learning are used. This can be highly efficient in terms of minimizing the number of experiments particularly when based on SFD and quantification of both experiment design space coverage and uncertainty of modeling accuracy. The uncertainty may be used to insert new design points judiciously on a basis of both local uncertainty reduction and global reduction of uncertainty. The end result is a trained machine learning model of both the response (e.g., performance data) and uncertainty over the parameter domain which may be used to improve the time and number of experimental iterations to determine optimal operating parameters.

The compiling of the historical parameters and/or historical performance data may be used to automate creation of a trained machine learning model, automate highly-efficient design of physical experiments in a principled convergent method, automate design of numerical experiments, enable optimal metrology (e.g., SEMs, TEMs, etc.), etc..

In some embodiments, machine learning modeling, analysis and data mining methods use integrated data and an integrated analysis environment. Data (e.g., historical parameters and/or historical performance data) for recipe development may span multiple sources that may be separated. To enable efficiency and use advanced computational and machine learning methods, data (e.g., historical parameters, historical performance data, etc.) may be integrated and recast to a form for these functions. A comprehensive dataframe may be used for any number of recipes including any number of processes and parameters. Response data (e.g., historical performance data) from any source associated with a recipe (e.g., metrology, spectroscopy, ellipsometry, plasma physics simulation, etc.) may be bound to the historical parameters. The historical parameters bound to historical performance data (e.g., in a dataframe) may be used for data mining, analysist, DOE, DOE augmentation, and machine learning. Analysis of coupon or substrate wafers could use the historical parameters and historical performance data and the analysis may be performed both within a given group such as a DOE or across groups.

In some embodiments, the historical parameters and the historical performance data is combined into regression and/or classification data that is used to generate one or more generalized parametric models (e.g., trained machined learning models) to be used for determining distributions over parameters, reports, recipe optimization, and/or variational statistics.

At block 524, the processing logic trains a machine learning model using data input including the sets of historical parameters (e.g., experimental designs or DOEs of process recipe parameters and/or historical recipes and parameters) and target output (e.g., target data) including the historical performance data (e.g., historical performance data and/or DOE) to generate a trained machine learning model. In some embodiments, the trained machine learning model uses one or more of; Bayesian Probabilistic Learning, Bayesian Regression or Classification, Gaussian Process Regression or Classification, Bayesian Neural Networks, Neural Network Gaussian Processes, Gaussian Process Regressor (GPR), Bayesian Probabilistic Learning, Bayesian, Deep Belief Network, Gaussian Mixture Model, and/or the like). The trained machine learning model may be used in sequential (e.g., adaptive) design for local or global optimization to implement a type of Bayesian Optimization based on an acquisition function derived from uncertainty functions from these methods. The trained machine learning model may also be used to model or optimize computationally expensive methods (e.g., use data from complex plasma simulations to train and optimize a general model with minimal number of added simulations).

In some embodiments, the training of the machine learning model is unsupervised (e.g., clustering, graphs, heat maps, etc.) and/or supervised (e.g., regression, classification, SFD augmentation, etc.).

The model and modeling methodology may use a probabilistic programming philosophy so the models and inferences from the model are inherently probabilistic and predict uncertainty (also referred to as credibility) in addition to the response (e.g., performance data) in the form of expectation or most-likely response for which it was trained. With a trained generalized model of this type, a target response can be predicted anywhere in the parameter domain and a determination can be made whether the target response is credible on a sound basis. Further advantages of Bayesian methods are also available. This is a significant departure from traditional statistical thinking and modeling and provides a unique benefit. As with the target response, uncertainty or functions derived from the model are a function distributed over the parameter space and may be used as a measure of how well understood or credible a target response is such as by searching for a peak in uncertainty.

At block 526, the processing determines whether uncertainty (e.g., level of uncertainty, lack of credibility uncertainty measure of the trained machine learning model) of the trained machine learning model (e.g., see FIG. 4B) meets a threshold uncertainty. The measure of uncertainty may be a function which describes uncertainty continuously. One functional form is referred to as an “acquisition function.” The acquisition function form may be used to determine peaks or troughs associated with uncertainty over the sampled parameter domain. Responsive to the uncertainty meeting the threshold uncertainty, the flow of method 500B ends. Responsive to the uncertainty not meeting the threshold uncertainty, the flow of method 500B continues to block 528.

In some embodiments, uncertainty of the trained machine learning model is an uncertainty value or range of values and the threshold uncertainty is a threshold uncertainty value or range of values. In some embodiments, uncertainty of the trained machine learning model is associated with a range of possible performance data 152 for particular parameters or a range of possible parameters for target performance data.

At block 528, the processing logic identifies one or more additional parameters (e.g., additional recipe parameters) and/or additional recipes (that include additional parameters) associated with the uncertainty of the trained machine learning model (e.g., additional sets of recipe parameters associated with a measure of peak uncertainty of the trained machine learning model over a range of parameters) to represent a simulated substrate with a predicted (expected) target response and a quantification of how credible the response is. In some embodiments, the historical parameters are associated with processes of a recipe used by substrate processing equipment to produce the substrates and the additional parameters are associated with updated processes of an updated recipe used by the substrate processing equipment to produce additional substrates. In some embodiments, the identifying of the additional parameters is based on local uncertainty reduction and global uncertainty reduction. In some embodiments, the uncertainty of the trained machine learning model is associated with target performance data (e.g., target thickness values) to be obtained using the additional parameters (e.g., uncertainty of performance data that would result from producing substrates using a recipe that includes the additional parameters). In some embodiments, identifying the additional parameters includes using a space filing design (SFD) and quantification of experiment design space coverage and uncertainty of modeling accuracy. The identifying of additional parameters associated with uncertainty may be used to perform adaptive augmentation (e.g., blocks 526-534).

At block 530, the processing logic causes one or more additional substrates to be produced by the substrate processing equipment based on the one or more additional parameters and/or additional recipes. The additional parameters may be identified as key parameters and the causing of additional substrates to be produced based on the additional parameters may be key experiments.

At block 532, the processing logic receives additional performance data of the one or more additional substrates produced based on the one or more additional parameters

At block 534, the processing logic further trains the machine learning model using additional data input including the additional parameters and additional target output (e.g., additional target data) including the additional performance data to update the trained machine learning model. Block 534 may be DOE design augmentation via further training the trained machine learning model. In this manner and within a cycle of training the probabilistic model, the target response and uncertainty are predicted and new experimental data points are selected to acquire data, and the probabilistic model is retrained. This approach and modeling method may systematically improve a recipe adaptively through a principled rigorous approach. In some embodiments, the processing logic further trains the machine learning model by augmentation at points of high uncertainty where the credibility of the predictive ability is lower than acceptable (e.g., augmenting the prior training with data input including the additional parameters and target data including the additional performance data). Flow continues to block 526 to determine whether uncertainty of the trained machine learning model (e.g., updated via blocks 528-534) meets a threshold uncertainty. Blocks 526-534 may repeat until the uncertainty of the trained machine learning model meets a threshold uncertainty.

In some embodiments, the processing logic performs Monte Carlo and optimization using the trained machine learning model to identify optimal parameters values and parametric trends. To optimize the recipe with limited amounts of data (e.g., less than 50 coupons and/or less than 50 experiments), the processing logic may perform cyclic learning with machine learning driven experiments to refine the trained machine learning model during development. Recipes (e.g., inputs) for experiments may be acquired as data files (e.g., extensible markup language (XML) files) from a cluster tool (e.g., etch tool) which are joined with critical dimension and categorical shape description responses (e.g., outputs, performance data) acquired from metrology data (e.g., SEM micrographs and CD-SEM) to create high-dimension feature vector dataframe. The high-dimension feature vector dataframe may be used for unsupervised and supervised learning. Unsupervised learning models may be used to gain insight on contributory variables and identify statistically unique experiments spanning this space. Supervised learning models may be trained for each response (e.g., performance data) and the most accurate supervised learning models may be used to form generalized models (e.g., the trained machine learning model). The models may be used in a Monte Carlo method to identify optimal variable sets, propose new experimental sets, and serve as a basis of physics-based modeling. To minimalize potential for impossible semantics, chemistry, or plasma parameters, a set of similarity and boundary conditions on the virtual coupons may be used and the data may be augmented with physics-based modeling to expand and diversify the dataset.

Coupons and corresponding recipes may span a wide range of parameters in many different processes. The response (e.g., performance data) to these parameter variations may be highly non-intuitive and result in various dimensional or shape characteristics that are to be co-optimized. One or more unsupervised learning models may be used to facilitate optimal use of limited data including correlation and collinearity analysis, latent feature analysis, heat maps and/or dendrograms to cluster similar coupons and determine most unique differentiating features of each and force-directed acyclic graphs to further show the relationship of real and virtual coupons. Supervised learning may be used for both determination of relative variable importance and for creation of generalized models of the key response variables and a cumulative variable. Variable importance estimation may be used to identify the variation space for Monte Carlo or optimization using the machine learning models. Models created for each response (e.g., performance data) may also be used to simulate and display the variation space for each variable. Monte Carlo simulation may be performed to create virtual coupons derived from real coupons. Graphical output may show the distribution over the parameter variation space as well as determination of the optimal response or cumulative response. Differential evolution optimization may be performed to determine optimal parameters for the top evolutions. In some embodiments, two sets of synthesized virtual coupons may be created and verified with experiments. One set may result in improvement over prior coupons. While the other set may be less optimal, after adding both sets to the training set, the overall model quality may be improved. A metric may be used in optimization based on degree of similarity from members of a-priori coupons from which models were trained. Cases may be shown accurate for virtual coupon experiments and real silicon confirmation coupons may be created.

The trained machine learning model is used for inference of a performance response from a new set of recipe parameters over the training parameter domain (e.g., the DOE). As previously described, Bayesian-derived methods are unique form conventional approaches in that Bayesian-derived methods provide a solution as a posterior probability distribution with expected values as a function and the uncertainty determined by means such as high-density-interval (HDI). Inference may be very fast and enable inferences over very large numbers of potential recipes along with a prediction of the uncertainty of the performance response. In some embodiments, the optimal parameters may be determined by grid expansion over all parameters and simple ordering in the inferred response. In some embodiments, the parameters may be determined through a numerical optimization method which minimizes a response cost function. Other methods are possible as well. Methods may provide a predicted optimal expected or likely value as the model is Bayesian and the associated uncertainty may be the determining value (e.g., the critical determining value) as to whether the expected value is credible. For values that appear to be optimal but that have unacceptable uncertainty, additional experiments are performed and used to update the given model.

FIG. 5C is a method 500C for using a trained machine learning model (e.g., model 190 of FIG. 1) to cause recipe optimization (e.g., to determine the recipe parameters that are to achieve a desired and credible target response).

Referring to FIG. 5C, at block 540 of method 500C, the processing logic receives a recipe request to determine one or more optimal sets of recipe parameters which can be used to produce one or more substrates having target performance objectives (e.g., target performance data). The recipe includes the operations and parameters in the trained model and the objective is to determine the one or more recipes that have parameters that are to meet the objective through methods that predict the response from the model (e.g., extracting one or more of the responses that meet the objective).

At block 542, processing logic identifies, based on the recipe, target performance data and objective. The target performance data corresponds to a specific trained model. Target performance data may include diverse metrology and other data such as thickness values of one or more layers, flatness value, etc. of substrates to be produced. Objectives can be specific values or derived values (e.g., a normalized thickness) or may simply be to minimize or maximize or minimize a value.

At block 544, processing logic provides the target performance data (e.g., as output) and/or objective to a trained machine learning model (e.g., the trained machine learning model of block generated by FIG. 5B) to infer the target response and uncertainty. In some embodiments, the trained machine learning model uses one or more of GPR or Bayesian Probabilistic Learning. The trained machine learning model was trained based on historical parameters and historical performance data and was further trained based on additional parameters identified based on model uncertainty and additional performance data of additional substrates produced based on the additional parameters (see FIG. 5B).

At block 546, processing logic obtains, from methods using the trained machine learning model, predictive data (e.g., predictive parameters, one or more inputs indicative of predictive parameters 148 of FIG. 1, predictive recipe parameters, predictive recipes, etc.). The predictive data may include target response and uncertainty distributions indicative of predictive recipes with parameters. The predictive recipes may include recipes chosen to improve overall model overall or those chosen with an aim of optimization. In some embodiments, the trained machine learning model was trained using historical parameters as input and historical performance data as output, target performance data is provided to the trained machine learning model (e.g., responsive to parameter extraction from the trained machine learning model), and predicted parameters are obtained (e.g., as one or more inputs) from the trained machine learning model (e.g., extracted from the trained machine learning model). In some embodiments, the trained machine learning model was trained using historical performance data as input and historical parameters as output, target performance data is provided as input to the trained machine learning model, and predicted parameters are obtained from output of the trained machine learning model. In some embodiments, the predictive parameters are associated with processes of the recipe received in block 540 to be used by the substrate processing equipment to produce substrates. In some embodiments, the processing logic obtains, from the trained machine learning model uncertainty distribution of the predictive parameters. In some embodiments, the obtaining of the predictive parameters includes using, based on the trained machine learning model, maximum a-posteriori probability (MAP) optimization to determine the predictive parameters associated with producing the substrates having target performance data.

In some embodiments, the processing logic obtains, from the trained machine learning model predictive probabilistic distributions of the parameters. In some embodiments, the processing logic reports the predictive parameters. In some embodiments, the processing logic performs numerical and/or stochastic optimization using the model to determine optimal parameter sets. In some embodiments, grid expansion is used to simulate over a grid on which the objective is subsequently sorted. In some objectives, variational statistics are gathered and used to determine the optimal parameter set which also meets sensitivity criterion (e.g., optimize recipe parameters for etch variance).

At block 548, processing logic determines optimal recipe parameters (e.g., optimizes the recipe) based on the predictive data. In some embodiments, the processing logic updates (e.g., replaces) parameters of one or more of the processes of the recipe with the predictive parameters determined using the trained machine learning model.

At block 550, processing logic causes substrates to be produced based on the recipe that has been optimized. At block 550, the processing logic may cause recipes to be written in a format for the substrate processing machine and may upload this recipe. Subsequently, the recipe may be used to produce the one or more substrates based on the recipe that has been optimized (e.g., based on the predictive parameters).

In some embodiments, processing logic receives current data (e.g., current parameters, current performance data) associated with the substrates and causes the trained machine learning model to be updated or further trained (e.g., re-trained) with the current data (e.g., with data input including the current parameters and target output including the current performance data).

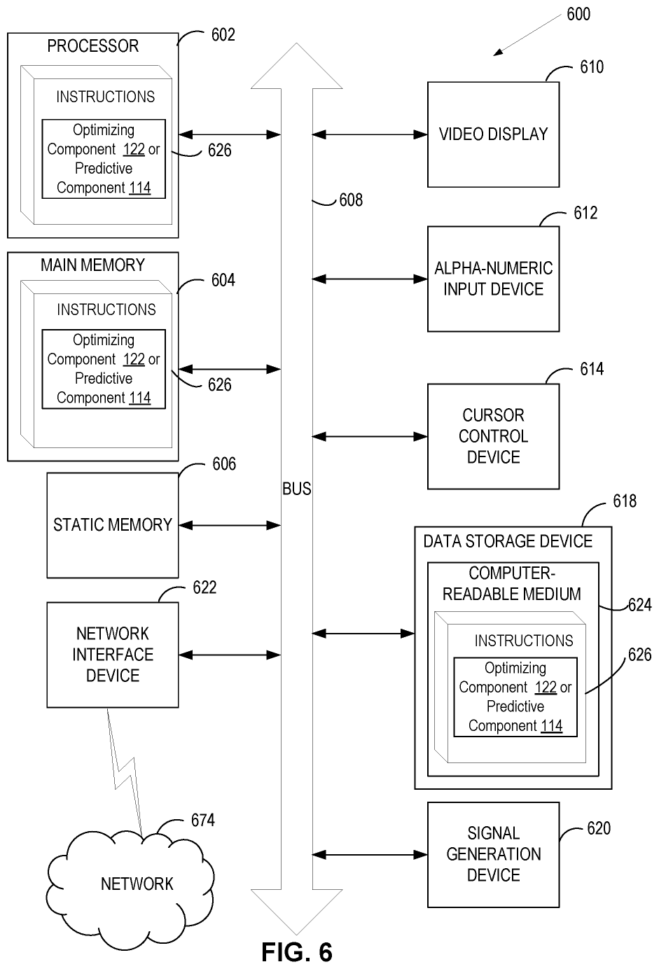

FIG. 6 is a block diagram illustrating a computer system 600, according to certain embodiments. In some embodiments, the computer system 600 is one or more of client device 120, predictive system 110, server machine 170, server machine 180, or predictive server 112.

In some embodiments, computer system 600 is connected (e.g., via a network, such as a Local Area Network (LAN), an intranet, an extranet, or the Internet) to other computer systems. In some embodiments, computer system 600 operates in the capacity of a server or a client computer in a client-server environment, or as a peer computer in a peer-to-peer or distributed network environment. In some embodiments, computer system 600 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 includes a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 616, which communicate with each other via a bus 608.

In some embodiments, processing device 602 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 600 further includes a network interface device 622 (e.g., coupled to network 674). In some embodiments, computer system 600 also includes a video display unit 610 (e.g., an LCD), an alphanumeric input device 612 (e.g., a keyboard), a cursor control device 614 (e.g., a mouse), and a signal generation device 620.

In some implementations, data storage device 616 includes a non-transitory computer-readable storage medium 624 on which store instructions 626 encoding any one or more of the methods or functions described herein, including instructions encoding components of FIG. 1 (e.g., optimization component 122, predictive component 114, etc.) and for implementing methods described herein (e.g., one or more of methods 500A-C).

In some embodiments, instructions 626 also reside, completely or partially, within volatile memory 604 and/or within processing device 602 during execution thereof by computer system 600, hence, in some embodiments, volatile memory 604 and processing device 602 also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as ASICS, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “training,” “identifying,” “further training,” “re-training,” “causing,” “receiving,” “providing,” “obtaining,” “optimizing,” “determining,” “updating,” “initializing,” “generating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general purpose computer system selectively programmed by a computer program stored in the computer system. Such a computer program is stored in a computer-readable tangible storage medium.

The methods and illustrative examples described herein are not inherently related to any particular computer or other apparatus. In some embodiments, various general purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
training a machine learning model with data input comprising one or more sets of historical recipe parameters associated with producing one or more substrates with substrate processing equipment and target data comprising historical performance data of the one or more substrates to generate a trained machine learning model;
identifying one or more sets of additional recipe parameters associated with a level of uncertainty of the trained machine learning model; and
further training the machine learning model with additional data input comprising the one or more sets of additional recipe parameters and additional target data comprising additional performance data of one or more additional substrates produced based on the one or more sets of additional recipe parameters to update the trained machine learning model.

2. The method of claim 1, wherein:
the one or more sets of historical recipe parameters are associated with processes of a recipe used by the substrate processing equipment to produce the one or more substrates; and
the one or more sets of additional recipe parameters are associated with updated processes of an updated recipe used by the substrate processing equipment to produce the one or more additional substrates.

3. The method of claim 1, wherein the identifying of the one or more sets of additional recipe parameters is based on local uncertainty reduction associated with the one or more sets of additional recipe parameters and global uncertainty reduction associated with the trained machine learning model.

4. The method of claim 1, wherein the historical performance data comprises one or more of thickness values, critical dimension (CD) values, shape parameter values, material property values, metrology measurement values, or sensor measurement values of one or more layers of the one or more substrates.

5. The method of claim 1, wherein the uncertainty of the trained machine learning model is associated with target performance data to be obtained using the one or more sets of additional recipe parameters.

6. The method of claim 1, the trained machine learning model being capable of generating, based on output of target performance data, one or more inputs indicative of predictive recipe parameters to be used by the substrate processing equipment to produce a plurality of substrates having the target performance data, wherein the predictive recipe parameters are to be used for recipe optimization.

7. The method of claim 1, wherein the trained machine learning model uses one or more of Gaussian Process Regression (GPR), Gaussian Process Classification, Bayesian Linear Regression, Probabilistic Learning, Bayesian Neural Networks, or Neural Network Gaussian Processes.

8. The method of claim 1, wherein the identifying of the one or more sets of additional recipe parameters comprises using one or more of: a space filling design (SFD); quantification and metrics of experiment design space coverage; grid expansion; numerical optimization; or Bayesian optimization.

9. The method of claim 1 further comprising:
causing the one or more additional substrates to be produced by the substrate processing equipment based on the one or more sets of additional recipe parameters; and
receiving the additional performance data of the one or more additional substrates produced based on the one or more sets of additional recipe parameters.

10. The method of claim 1, wherein:
the data input comprises one or more historical recipes comprising the one or more sets of historical recipe parameters; and
the additional data input comprises one or more additional recipes comprising the one or more sets of additional recipe parameters.

11. A method comprising:
identifying target performance data of a substrate to be produced by substrate processing equipment;
providing the target performance data to a trained machine learning model that uses one or more of Gaussian Process Regression (GPR), Bayesian linear regression, Probabilistic Learning, Bayesian Neural Networks, or Neural Network Gaussian Processes; and
obtaining, from the trained machine learning model, predictive data indicative of predictive recipe parameters to be used by the substrate processing equipment to produce one or more substrates having the target performance data.

12. The method of claim 11, wherein the predictive data is indicative of predictive recipes comprising the predictive recipe parameters.

13. The method of claim 11, the trained machine learning model having been:
trained based on one or more sets of historical recipe parameters and historical performance data; and
further trained based on one or more sets of additional recipe parameters identified based on model uncertainty and additional performance data of one or more additional substrates produced based on the one or more sets of additional recipe parameters.

14. The method of claim 11, wherein the predictive recipe parameters are associated with processes of a recipe to be used by the substrate processing equipment to produce the one or more substrates.

15. The method of claim 11, wherein the target performance data comprises one or more of thickness values, critical dimension (CD) values, shape parameter values, shape description values, material property values, metrology measurement values, or sensor measurement values of one or more layers of the substrate, and wherein the method further comprises obtaining, from the trained machine learning model, uncertainty distributions over parameter space, the parameter space comprising the predictive recipe parameters.

16. The method of claim 11 further comprising:
receiving a recipe to produce the one or more substrates having the target performance data; and
responsive to obtaining the predictive data indicative of the predictive recipe parameters, optimizing the recipe based on the predictive recipe parameters.

17. The method of claim 11, wherein the obtaining of the predictive data indicative of predictive recipe parameters comprises using, based on the trained machine learning model, maximum a posteriori probability (MAP) optimization to determine optimal predictive recipe parameters associated with producing the one or more substrates having the target performance data.

18. A system comprising:
a memory; and
a processing device coupled to the memory, the processing device to:
train a machine learning model with data input comprising one or more sets of historical recipe parameters associated with producing one or more substrates with substrate processing equipment and target data comprising historical performance data of the one or more substrates to generate a trained machine learning model;
identify one or more sets of additional recipe parameters associated with a level of uncertainty of the trained machine learning model; and
further train the machine learning model with additional data input comprising the one or more sets of additional recipes parameters and additional target data comprising additional performance data of one or more additional substrates produced based on the one or more sets of additional recipe parameters to update the trained machine learning model.

19. The system of claim 18, wherein the level of uncertainty is evaluated over an acquisition function of the trained machine learning model.

20. The system of claim 18, wherein:
the one or more sets of historical recipe parameters are associated with processes of a recipe used by the substrate processing equipment to produce the one or more substrates; and
the one or more sets of additional recipe parameters are associated with updated processes of an updated recipe used by the substrate processing equipment to produce the one or more additional substrates.
